(19) United States
(12) Patent Application Publication
(10) Pub. No.: US 2012/0063478 A1
(43) Pub. Date: Mar. 15, 2012

(54) SURFACE PLASMON BAND-EDGE LASER

(75) Inventor: Yeonsang PARK, Seoul (KR)

(73) Assignee: SAMSUNG ELECTRONICS CO., LTD., Suwon-si (KR)

(21) Appl. No.: 13/095,022

(22) Filed: Apr. 27, 2011

(30) Foreign Application Priority Data
Sep. 13, 2010 (KR) 10-2010-0089464

(51) Int. Cl. H01S 3/14

(52) U.S. Cl. 372/39

(57) ABSTRACT

Provided is a surface plasmon band-edge laser including a gain media having quantum dots configured to enable laser oscillation using surface plasmon resonance. The gain media has a periodic structure and is formed on a metal surface.

### CROSS-REFERENCE TO RELATED APPLICATION

This application claims priority from Korean Patent Application No. 10-2010-0089464, filed on Sep. 13, 2010, in the Korean Intellectual Property Office, the disclosures of which are incorporated herein by reference.

### BACKGROUND

1. Field

Apparatuses consistent with exemplary embodiments relate to a surface plasmon band-edge laser, and more particularly, to a band-edge laser having quantum dots as gain media and capable of lasing to output laser beams having a light spot smaller than a laser diffraction limit.

2. Description of the Related Art

In general, an optical integrated circuit (IC) is an optical circuit in which a variety of optical devices configured to perform various operations, such as an emission operation, an optical detection operation, an optical amplification operation, and an optical modulation operation, are integrated on a single substrate. For example, a light source, a photodiode (PD), a light waveguide, a lens, a diffraction grating, and an optical switch may be mounted on a single substrate. An optical IC may be applied in various fields related to, for example, an optical recording/reproduction apparatus, an optical communication apparatus, a display apparatus, and an optical computer.

In optical ICs, lasers are widely used as light sources. A wide variety of lasers have been developed and utilized according to desired power, oscillation wavelength, and/or oscillation method. In order to increase the integration density of an optical IC, emitted laser beams forming very small light spots of, for example, 1 μm or less, are desired. Also, laser apparatuses themselves are being downscaled. However, currently proposed laser structures have specific limits in reducing the size of light spots due to their diffraction limits. Thus, more attempts are being made at developing new laser structures to overcome the laser diffraction limits.

### SUMMARY

The following description relates to a surface plasmon band-edge laser capable of outputting laser beams having a light spot smaller than a laser diffraction limit.

Additional exemplary aspects will be set forth in part in the description which follows and, in part, will be apparent from the description, or may be learned by practice of the presented embodiments.

According to an aspect of an exemplary embodiment, a surface plasmon band-edge laser includes: a metal layer; and a gain medium layer disposed on the metal layer and having a periodic structure.

For example, the gain medium layer may include quantum dots.

The periodic structure of the gain medium layer may be configured to amplify surface plasmon light generated due to surface plasmon resonance at an interface between the metal layer and the gain medium layer.

The gain medium layer having the periodic structure may have a band-edge condition determined by the periodic structure, configured such that of the surface plasmon light, light having a wavelength which satisfies the band-edge condition is be amplified.

The gain medium layer may include quantum dots, and an emission wavelength of the quantum dots may be equal to the wavelength that satisfies the band-edge condition.

For instance, the gain medium layer may have a thickness of about 1 to 100 nm.

A material of the metal layer may include, for example, silver (Ag) or gold (Au).

The periodic structure of the gain medium layer may include a plurality of parallel rod-shaped gain media arranged at a constant interval.

For example, the periodic structure of the gain medium layer may include a plurality of recesses formed to wholly or partially penetrate the gain medium layer in a vertical direction and arranged in a periodic manner.

The arrangement of the plurality of recesses may include, for example, a type of a plurality of honeycombs, a type of a plurality of triangles, or a type of a plurality of rectangles.

The recesses may be filled with, for example, a transparent material.

### BRIEF DESCRIPTION OF THE DRAWINGS

These and/or other aspects will become apparent and more readily appreciated from the following description of exemplary embodiments, taken in conjunction with the accompanying drawings in which:

FIG. 1 is a perspective view of a surface plasmon band-edge laser according to an exemplary embodiment;

FIG. 2 is a diagram of a periodic structure of a gain medium layer of a surface plasmon band-edge laser according to another exemplary embodiment;

FIG. 3 is a diagram of a surface plasmon band-edge laser having the gain medium layer shown in FIG. 2, according to another exemplary embodiment;

FIG. 4 is a graph showing a 1-dimensional band-edge gain enhancement effect formed by a 1-dimensional periodic structure of a gain medium;

FIG. 5 is a graph showing a band-structure and a band-edge formed by a gain medium having a 2-dimensional periodic structure;

FIG. 6 is a graph showing emission characteristics of quantum dots as an example of a gain medium, according to an exemplary embodiment; and

FIG. 7 is a graph showing emission characteristics of a surface plasmon band-edge laser according to an exemplary embodiment.

### DETAILED DESCRIPTION

Reference will now be made in detail to exemplary embodiments, which are illustrated in the accompanying drawings, wherein like reference numerals refer to the like elements throughout. In this regard, the exemplary embodiments may have different forms and should not be construed as being limited to the descriptions set forth herein. Accordingly, embodiments are merely described below, by referring to the figures, to explain aspects of the present description.

In the drawings, the thicknesses of layers and regions are exaggerated for clarity.

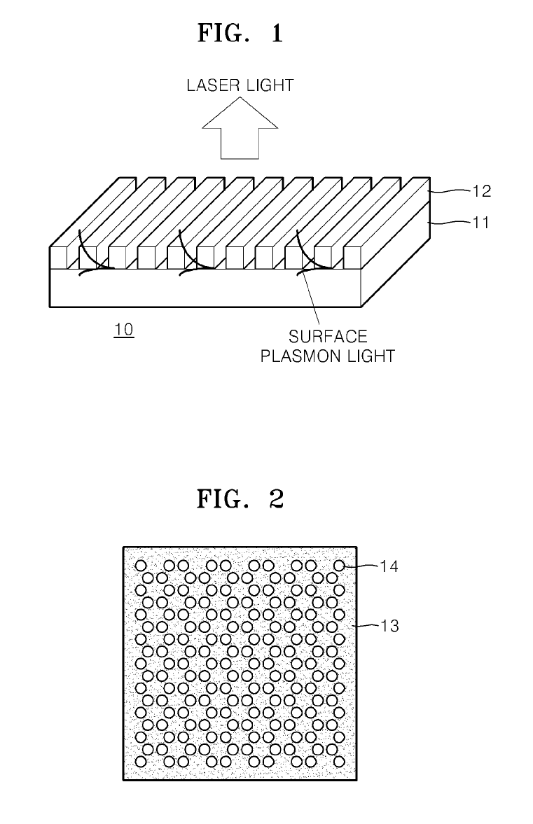

FIG. 1 is a perspective view of a surface plasmon band-edge laser 10 according to an exemplary embodiment. Referring to FIG. 1, the surface plasmon band-edge laser 10 according to the present embodiment may include a metal layer 11 and a gain medium layer 12 having a periodic structure disposed on the metal layer 11.

As will be described in detail later, the metal layer 11 may cause surface plasmon resonance at an interface between the metal layer 11 and the gain medium layer 12. To do this, the metal layer 11 may be formed of a material apt to cause surface plasmon resonance, for example, silver (Ag) or gold (Au). In addition, the metal layer 11 may be formed of a metal, such as copper (Cu), lead (Pb), indium (In), tin (Sn), or cadmium (Cd).

The gain medium layer 12 may be a layer configured to enable stimulated emission and amplification of light. For example, the gain medium layer 12 may include a plurality of quantum dots. The quantum dots refer to a semiconductor material having a crystal structure with a size of several nm less than the Bohr exciton radius. While the quantum dots contain a large number of electrons, the number of free electrons is limited to about 1 to 100. As a result, the electrons of the quantum dots have discontinuous energy levels. Thus, the quantum dots may have different electrical and optical characteristics than a bulk-level semiconductor having a continuous band. For example, since the energy levels of the quantum dots vary according to the size thereof, a bandgap may be controlled by simply changing the size of the quantum dots. In other words, an emission wavelength may be easily controlled by adjusting only the size of the quantum dots. Furthermore, since the quantum dots have a high gain, even if a relatively great optical loss occurs due to the metal layer 11, laser oscillation may be enabled. That is, when quantum dots with a high gain are used as the gain medium layer 12, a gain caused by the quantum dots may surpass loss caused by the metal layer 11, thereby enabling optical amplification.

The gain medium layer 12 may have a periodic repeated structure to provide a band structure in which light exists only in a specific energy band. As shown in FIG. 1, the gain medium layer 12 may include a plurality of parallel rod-shaped gain media disposed at a predetermined interval. However, the periodic structure of the gain medium layer 12 is not limited thereto.

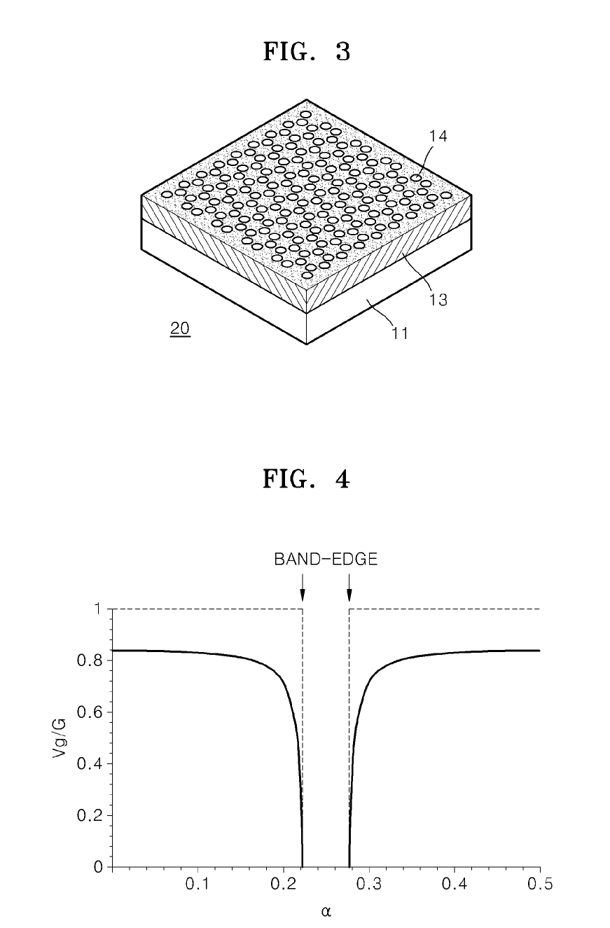

FIG. 2 is a diagram of a periodic structure of a gain medium layer 13 of a surface plasmon band-edge laser according to another exemplary embodiment, and FIG. 3 is a diagram of a surface plasmon band-edge laser 20 having the gain medium layer 13 shown in FIG. 2, according to another exemplary embodiment. As shown in FIGS. 2 and 3, the periodic structure of the gain medium layer 13 may include a plurality of recesses 14 arranged in a periodic manner and formed to wholly or partially penetrate the gain medium layer 13 in a vertical direction. FIG. 2 illustrates that the plurality of recesses 14 are arranged in a honeycomb shape. However, the arrangement of the recesses 14 is not limited thereto, and the recesses 14 may be arranged in a polygonal shape, such as a plurality of triangles or a plurality of rectangles, or combinations thereof. The arrangement of the recesses 14 may be variously designed according to a desired oscillation wavelength as long as the recesses 14 have a generally periodic repeating structure. Also, the recesses 14 may be filled with a transparent dielectric material including air.

Hereinafter, operations of the surface plasmon band-edge lasers 10 and 20 having the above-described structures will be described in detail.

To begin with, excitation light is incident on the gain medium layer 12 or 13 of the surface plasmon band-edge laser 10 or 20. The excitation light may have a shorter wavelength than oscillation wavelengths of the surface plasmon band-edge laser 10 or 20. For example, when the oscillation wavelength of the surface plasmon band-edge laser 10 or 20 is designed to be in a blue wavelength range, the excitation light may have an ultraviolet (UV) wavelength. Also, when the oscillation wavelength of the surface plasmon band-edge laser 10 or 20 is designed to be in a red wavelength range, the excitation light may have a blue wavelength. Thus, the gain medium layer 12 or 13 including, for example, quantum dots, may be excited due to the excitation light to generate light having a specific wavelength. Here, the wavelength of the light generated by the gain medium layer 12 or 13 may be equal to the oscillation wavelength of the surface plasmon band-edge laser 10 or 20.

Afterwards, the light generated by the gain medium layer 12 or 13 may cause surface plasmon resonance at an interface between the gain medium layer 12 or 13 and the metal layer 11. A surface plasmon refers to a surface electromagnetic wave (or surface electromagnetic light) generated at an interface between a metal layer and a dielectric material. It is known that a surface plasmon occurs due to charge density oscillation caused on a surface of a metal layer when light having a specific wavelength is incident on the metal layer. Although light generated due to surface plasmon resonance has a relatively high intensity, the light is an evanescent wave having a short effective distance. A wavelength of light for causing surface plasmon resonance may depend on, for example, a material of a metal layer or a refractive index of a dielectric material. For example, a refractive indexes of the gain medium layer 12 or 13 and a material of the metal layer 11 may be selected to be such that surface plasmon resonance occurs due to the wavelength of the light generated by the gain medium layer 12 or 13.

Meanwhile, as described above, when the gain medium layer 12 or 13 has a periodic repeated structure, the gain medium layer 12 or 13 may have a band structure in which light exists in only a specific energy band. In this case, light may be confined for a long time in the repeated structure of the gain medium layer 12 or 13 while greatly reducing a group velocity of the light at a band edge where a Brillouin zone of the band structure ends. Thus, it may be considered that an effective length of the band structure is infinitely increased from an optical viewpoint. While light remains in the structure of the gain medium layer 12 or 13, since light is continuously generated by the gain medium layer 12 or 13, light may be accumulated in the band structure. Hence, gains of the surface plasmon band-edge laser 10 or 20 may be increased. This phenomenon may be referred to as band-edge gain enhancement.

FIG. 4 is a graph showing a 1-dimensional band-edge gain enhancement effect formed by the 1-dimensional periodic structure of the gain medium layer 12 (e.g., the periodic structure shown in FIG. 1). In FIG. 4, an ordinate denotes a ratio VG/G of group velocity VG to gain G, and an abscissa denotes α. Here, α may be defined as (a·n₁)/λ=(b·n₂)/λ when the 1-dimensional periodic structure alternates between a first length of a (refractive index n₁) and a second length of b (refractive index n₂). Referring to FIG. 4, it can be seen that the ratio VG/G is approximately 0 at a band edge. Thus, it may be inferred that the group velocity is approximately 0 and a gain is greatly enhanced.

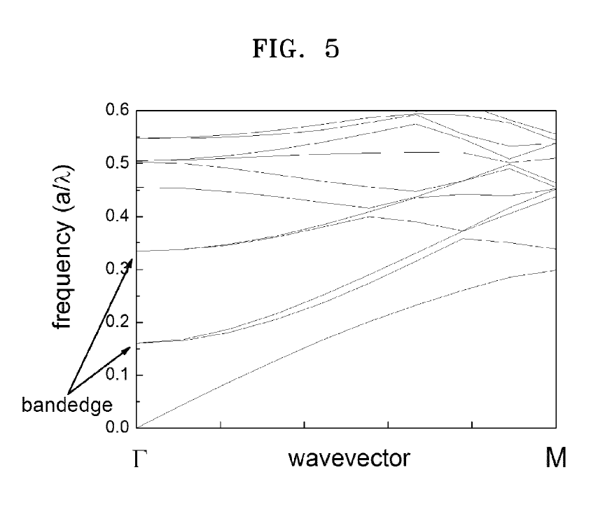

FIG. 5 is a graph showing a band-structure and a band-edge formed by a gain medium having a 2-dimensional periodic structure.

The 2-dimensional periodic structure may include an arrangement of unit cells spaced from each other at intervals and are arranged in a repeating pattern. In plan view, each of the cells may be rod-shaped or polygonal-shaped. For example, FIG. 5 is a graph showing a band-structure and a band-edge formed by a gain medium having a 2-dimensional periodic structure, such as the gain medium layer 13 having the recesses 14 arranged in a honeycomb shape including, for example, regular-hexagonal unit cells, as shown in FIGS. 2 and 3. In FIG. 5, an ordinate denotes a frequency a/λ normalized by a lattice constant a of the 2-dimensional periodic structure, and an abscissa denotes a wavevector from a center Γ of one regular-hexagonal unit cell of the 2-dimensional periodic structure to a center M of one side of the regular-hexagonal unit cell. As shown in FIG. 5, a far more complicated band structure is formed in the 2-dimensional periodic structure. According to a plurality of curves of FIG. 5, a group velocity is approximately 0 at a spot where a gradient dw/dk of a tangent line reaches 0 (or a spot where a curve is almost parallel to the abscissa). For example, when the normalized frequency a/λ reaches about 0.16 or 0.33 at the center Γ, the group velocity is approximately 0. In this case, if light passing through the centers Γ of the regular-hexagonal unit cells is selected to have the normalized frequency a/λ of 0.16 or 0.33, a gain may be greatly enhanced.

As can be seen from the graphs of FIGS. 4 and 5, band-edge gain enhancement occurs only with a specific wavelength according to the shape of the periodic structure of the gain medium layers 12 and 13. Since the band structure depends on the shape of the periodic structure of the gain medium layers 12 and 13, a band-edge condition for causing the band-edge gain enhancement may be determined according to the shape of the periodic structure of the gain medium layers 12 and 13. Accordingly, the periodic structure of the gain medium layers 12 and 13 may be designed to be such that the oscillation wavelengths of the surface plasmon band-edge lasers 10 and 20 satisfy the band-edge condition. Also, a size and a material of the quantum dots of the gain medium layers 12 and 13 may be selected to be such that a wavelength of light generated by the quantum dots of the gain medium layers 12 and 13 is equal to a wavelength that satisfies the band-edge condition.

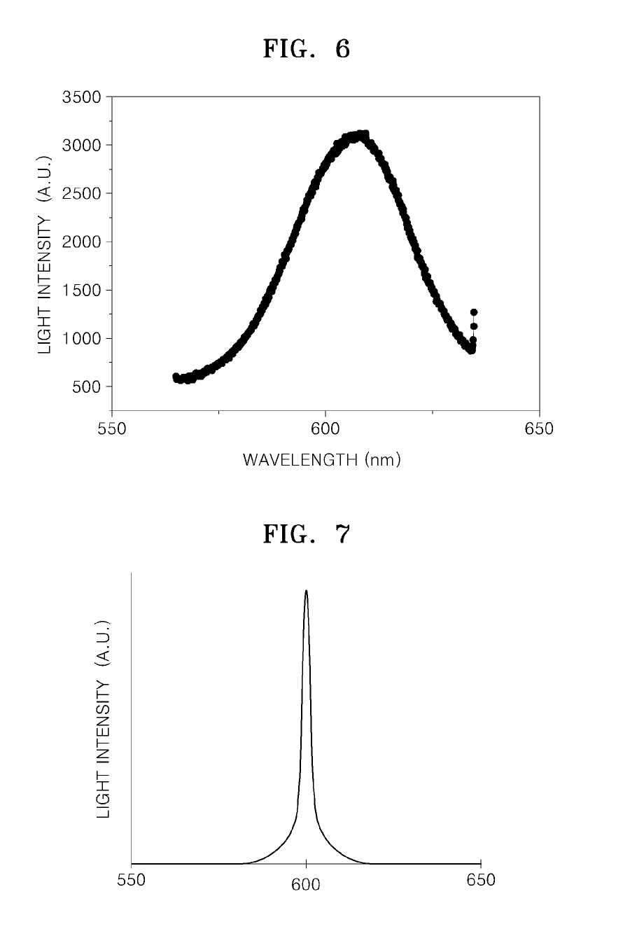

Thus, out of surface plasmon light generated due to surface plasmon resonance at an interface between the gain medium layers 12 and 13 and the metal layer 11, light having the wavelength that satisfies the band-edge condition may be amplified by the periodic structure of the gain medium layers 12 and 13. When the wavelength of the light generated by the quantum dots of the gain medium layers 12 and 13 is equal to the wavelength that satisfies the band-edge condition, light having the wavelength that satisfies the band-edge condition, out of the surface plasmon light, may be increased. Hence, light loss may be reduced, and efficiency of the surface plasmon band-edge lasers 10 and 20 may be enhanced. The amplified surface plasmon light may be emitted as laser light through a top surface of the surface plasmon band-edge laser 10 or 20. For example, as shown in FIG. 6, when the quantum dots of the gain medium layer 12 or 13 have a relatively wide wavelength band with a central wavelength of about 600 nm, the surface plasmon band-edge laser 10 or 20 according to an exemplary embodiments may emit light having a relatively narrow wavelength band with a central wavelength of about 600 nm as shown in FIG. 7.

As described above, since the surface plasmon band-edge laser 10 or 20 according to an exemplary embodiment may amplify surface plasmon light having a relatively short effective distance, the gain medium layer 12 or 13 may not be formed to a great thickness. For example, the gain medium layer 12 or 13 may be formed to a thickness of about 1 to 100 nm. When the gain medium layer 12 or 13 is formed to such a small thickness, since only pure surface plasmon light may be amplified, noise caused by other light may not occur. Also, the surface plasmon band-edge laser 10 or 20 may be capable of being downscaled and thinned. Accordingly, the surface plasmon band-edge laser 10 or 20 may be easily integrated with an optical integrated circuit (IC). Furthermore, in the surface plasmon band-edge laser 10 or 20 according to an exemplary embodiment, since the metal layer 11 may function as a substrate, the integration of the surface plasmon band-edge laser 10 or 20 with the optical IC may be further facilitated. In addition, since the surface plasmon band-edge laser 10 or 20 according to an exemplary embodiment may have surface oscillation and emit light through a top surface thereof, the surface plasmon band-edge laser 10 or 20 may provide a laser beam with a light spot smaller than a conventional diffraction limit.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A surface plasmon band-edge laser comprising:
a metal layer; and
a gain medium layer disposed on the metal layer and having a periodic structure.

2. The laser of claim 1, wherein the gain medium layer comprises quantum dots.

3. The laser of claim 1, wherein the periodic structure of the gain medium layer is configured to amplify surface plasmon light generated due to surface plasmon resonance at an interface between the metal layer and the gain medium layer.

4. The laser of claim 3, wherein the gain medium layer has a band-edge condition determined by the periodic structure and configured such that the surface plasmon light having a wavelength that satisfies the band-edge condition is amplified.

5. The laser of claim 4, wherein the gain medium layer comprises quantum dots configured such that an emission wavelength of the quantum dots is equal to a wavelength that satisfies the band-edge condition.

6. The laser of claim 1, wherein a thickness of the gain medium layer is about 1 to 100 nm.

7. The laser of claim 1, wherein the metal layer is silver or gold.

8. The laser of claim 1, wherein the periodic structure of the gain medium layer comprises a plurality of parallel rod-shaped gain media arranged at a constant interval.

9. The laser of claim 1, wherein the periodic structure of the gain medium layer comprises a plurality of recesses arranged in a periodic manner, wherein the plurality of recesses wholly or partially penetrate the gain medium layer in a direction substantially perpendicular to an interface between the metal layer and the gain medium layer.

10. The laser of claim 9, wherein the periodic arrangement of the plurality of recesses comprises a repeating pattern of one of honeycomb shapes, triangles, and rectangles.

11. The laser of claim 9, wherein the recesses are filled with a transparent material.

12. The laser of claim 11, wherein the transparent material is a dielectric material.

13. The laser of claim 2, wherein at least one of a size of the quantum dots and a material of the quantum dots is configured such that an emission wavelength of the quantum dots satisfies the band-edge condition.

14. A surface plasmon band-edge laser comprising:
a metal layer; and
a gain medium layer disposed on the metal layer, the gain medium layer comprising a plurality of unit cells arranged in a repeating pattern and spaced from each other by a predetermined interval.

15. The laser of claim 14, wherein, in plan view, each of the unit cells have a rod shape or a polygonal shape.

16. The laser of claim 14, wherein the gain medium layer comprises at least one recess formed in the gain medium layer or which fully penetrates the gain medium layer.

17. The laser of claim 16, wherein the at least one recess is formed between the unit cells.

18. An optical integrated circuit comprising the surface plasmon band-edge laser of claim 14,
wherein the metal layer of the surface plasmon band-edge laser is a substrate of the optical integrated circuit.
